(19) United States
(12) Patent Application Publication
(10) Pub. No.: US 2002/0178996 A1
(43) Pub. Date: Dec. 5, 2002

(54) Wind direction indicator

(76) Inventor: Bob Damberger, Donalda (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/138,037

(22) Filed: May 2, 2002

(30) Foreign Application Priority Data
May 2, 2001 (CA) 2,345,898

(51) Int. Cl. G09F 17/00

(52) U.S. Cl. 116/173

(57) ABSTRACT

A wind direction indicator includes a rigid body having a first end and a second end. Deflectors for deflecting the body in response to wind movement are positioned at the first end of the body. A pivotal mounting is provided for pivotally mounting the body for movement about a substantially vertical pivot axis.

### FIELD OF THE INVENTION

The present invention relates to a wind direction indicator

### BACKGROUND OF THE INVENTION

Many jurisdictions have laws which require all installations handling toxic or explosive gases to have a wind direction indicator. These laws were developed in response to a series of tragedies in which service personnel were overcome by fumes. An example of such an installation is an oil and gas well which produces sour gas.

A wind direction indicator serves to inform service personnel of wind direction. Service personnel can then reduce the potential danger posed by exposure to fumes from sour gas leaks by approaching the sour gas well with the wind at their backs. The wind is, therefore, blowing any fumes away from the service personnel as they approach the sour gas well. This provides service personnel with a route for escape if sour gas fumes are detected as they approach the sour gas well. It also provides a route for rescue, if the danger is not identified until after one of the service personnel has been overcome by fumes.

The wind direction indicators currently in wide spread use at sour gas wells are wind socks. These wind socks are identical to wind socks used in the aviation industry. The problem with the use of wind socks is that they tend to wear out in a matter of a few months. This requires diligent maintenance programs to ensure the wind socks are operational. Unfortunately, many sour gas wells are in remote locations that are infrequently visited. It is estimated that more than half and perhaps as many as three quarters of wind socks at these remote locations are inoperable.

An alternative and more durable form of wind direction indicator is a weather vane. Weather vanes have rigid planar bodies which are pivotally mounted. They are frequently cut into the shape of animals. For example, weather cocks are in the shape of a rooster. Weather vanes have, however, been found to be unsuitable for use by the oil and gas industry as wind direction indicators. The reason is that service personnel cannot tell wind direction when viewing the weather vane from an end.

### SUMMARY OF THE INVENTION

What is required is a more durable form of wind direction indicator suitable for use at installations where potentially toxic or explosive gases are handled.

According to the present invention there is provided a wind direction indicator which includes a rigid body having a first end, a second end and opposed sides. Means for deflecting the body in response to wind movement are positioned at the first end of the body and extend from the opposed sides. Means is provided for pivotally mounting the body for movement about a substantially vertical pivot axis.

With the wind direction indicator, as described above, the means for deflecting the body in response to wind movement serve the dual purpose of deflecting the body in response to wind movement and giving the body three dimensional visibility. It, therefore, becomes possible for ground service personnel to identify wind direction with reference to the wind direction indicator regardless of their position relative to the wind direction indicator. The wind direction indicator, as described above, is more accurate than a wind sock. A wind sock requires a minimum wind speed in order to operate. The wind direction indicator, as described above, operates with wind speeds that would be insufficient to operate a wind sock. The preferred means for deflecting the body are deflectors which extend outwardly from the opposed sides at the first end of the body at an angle toward the second end of the body.

Although beneficial results may be obtained through the use of the wind direction indicator, as described above, it may be difficult for service personnel approaching a remote sour gas well by helicopter to ascertain wind direction. Even more beneficial results may, therefore, be obtained by providing a top cap which overlies the rigid planar body. The top cap is tapered from the first end of the body to the second end of the body, such that the orientation of the body can be determined from an aircraft.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is perspective view of a first embodiment of wind direction indicator fabricated in accordance with the teachings of the present invention.

FIG. 2 is a right side elevation view of the wind direction indicator illustrated in FIG. 1.

FIG. 3 is a left side elevation view of the wind direction indicator illustrated in FIG. 1.

FIG. 4 is a top plan view of the wind direction indicator illustrated in FIG. 1.

FIG. 5 is a bottom plan view of the wind direction indicator illustrated in FIG. 1.

FIG. 6 is a first end elevation view of the wind direction indicator illustrated in FIG. 1.

FIG. 7 is a second end elevation view of the wind direction indicator illustrated in FIG. 1.

FIG. 8 is perspective view of a second embodiment of wind direction indicator fabricated in accordance with the teachings of the present invention.

FIG. 9 is a right side elevation view of the wind direction indicator illustrated in FIG. 8.

FIG. 10 is a left side elevation view of the wind direction indicator illustrated in FIG. 8.

FIG. 11 is a top plan view of the wind direction indicator illustrated in FIG. 8.

FIG. 12 is a bottom plan view of the wind direction indicator illustrated in FIG. 8.

FIG. 13 is a first end elevation view of the wind direction indicator illustrated in FIG. 8.

FIG. 14 is a second end elevation view of the wind direction indicator illustrated in FIG. 8.

FIG. 15 is a side elevation, in section, of a mounting for the wind direction indicators illustrated in FIGS. 1 and 8.

### DETAILED DESCRIPTION OF THE PREFERRED EMBODIMENT

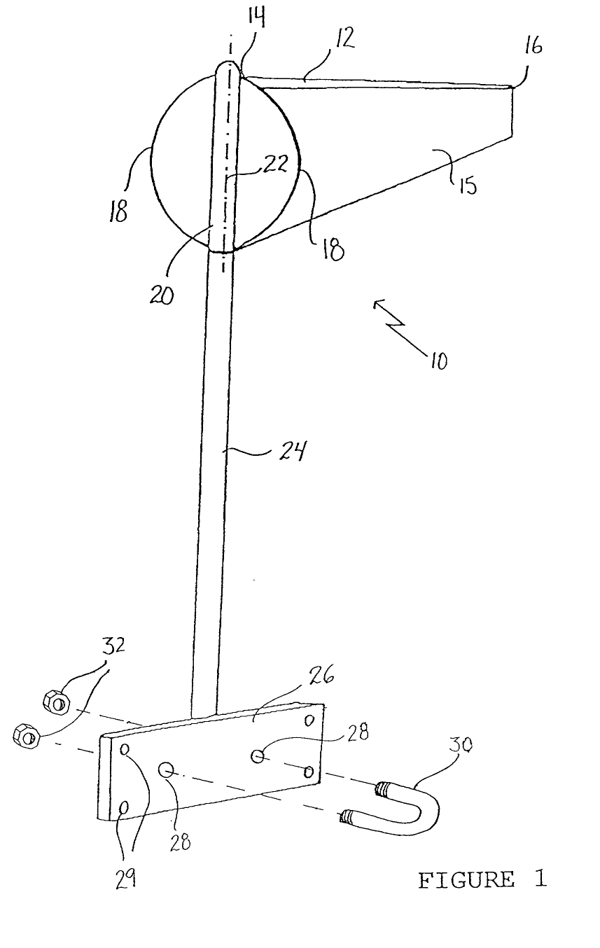

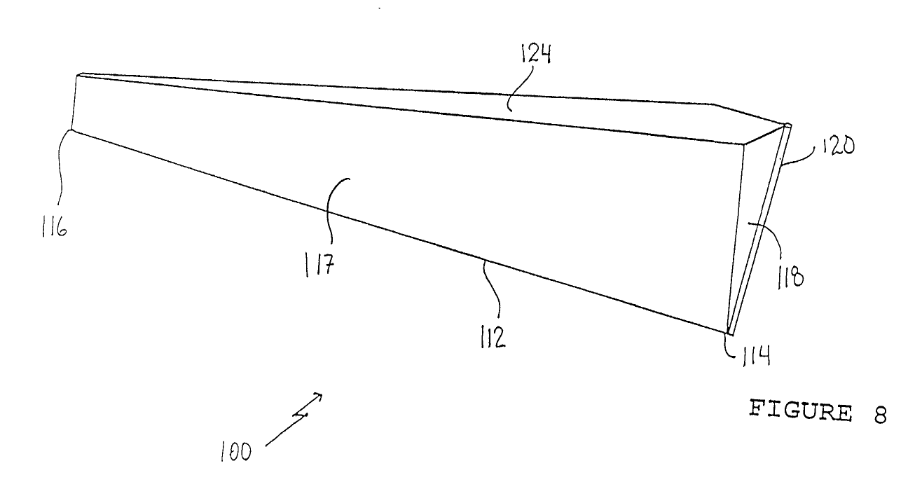

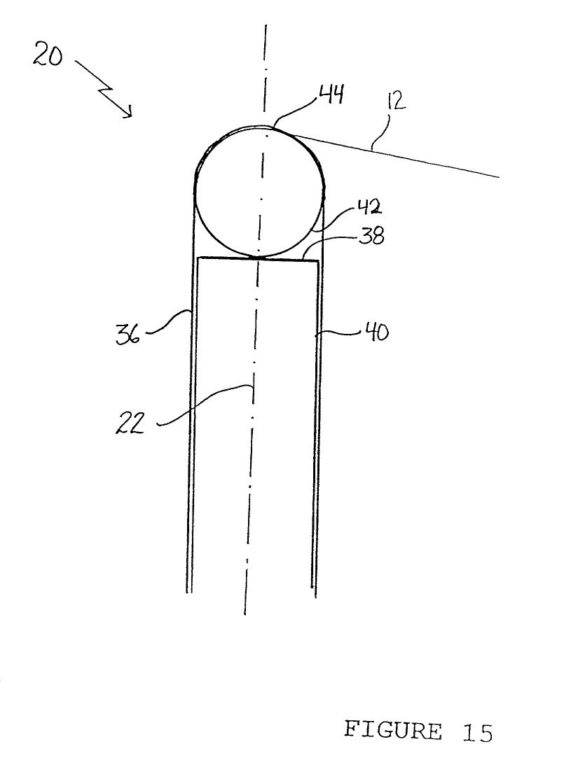

Two preferred embodiments of wind direction indicators generally identified by reference numeral 10 and 100, respectively, will now be described. Wind direction indicator 10 will be described with reference to FIGS. 1 through 7. Wind direction indicator 100 will be described with reference to FIGS. 8 through 14. A mounting common to both with be described with reference to FIG. 15.

Structure and Relationship of Parts:

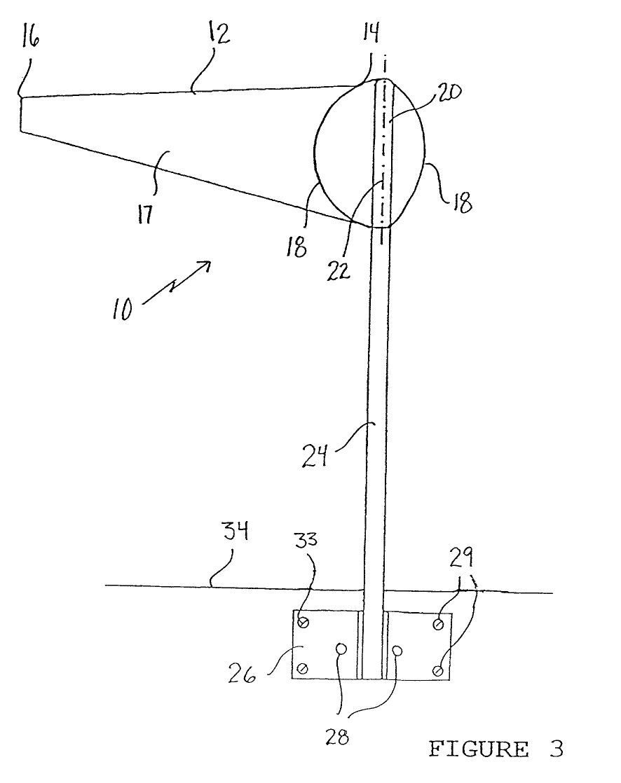

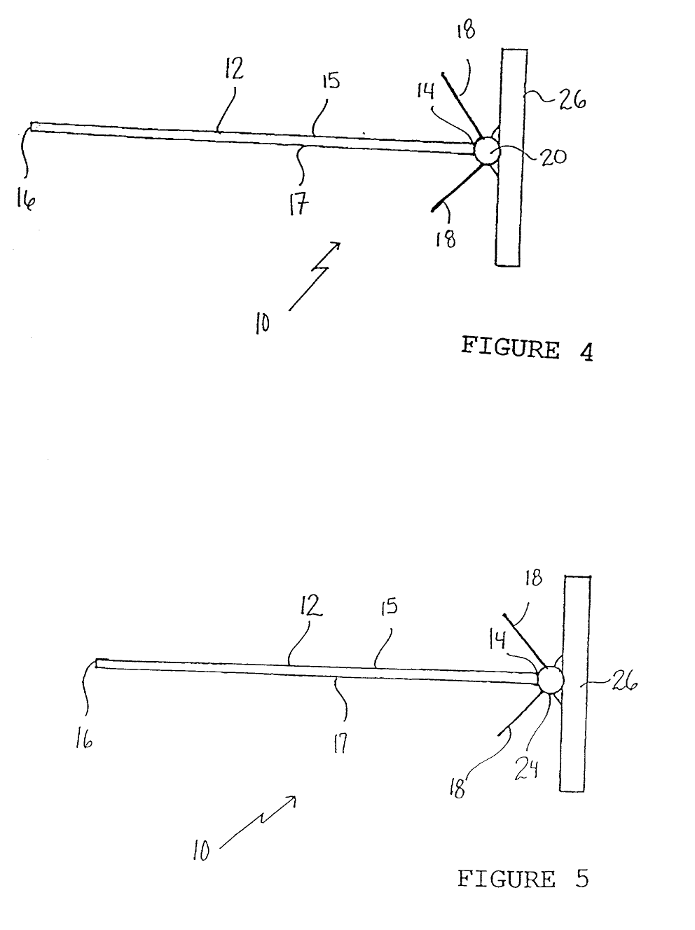

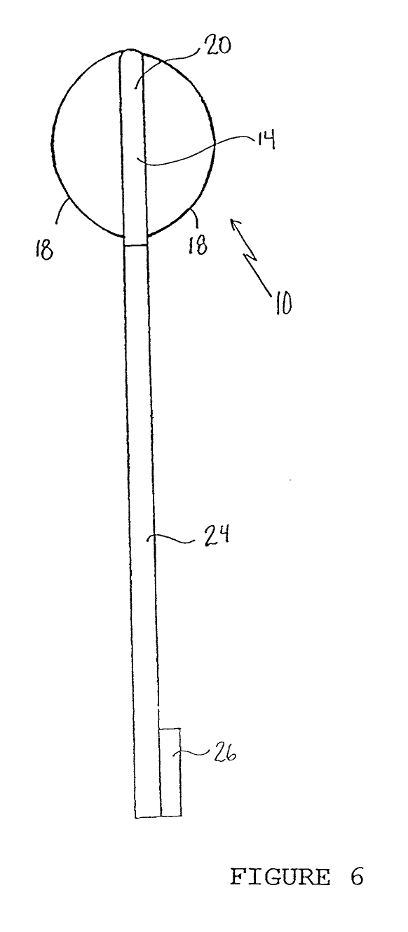

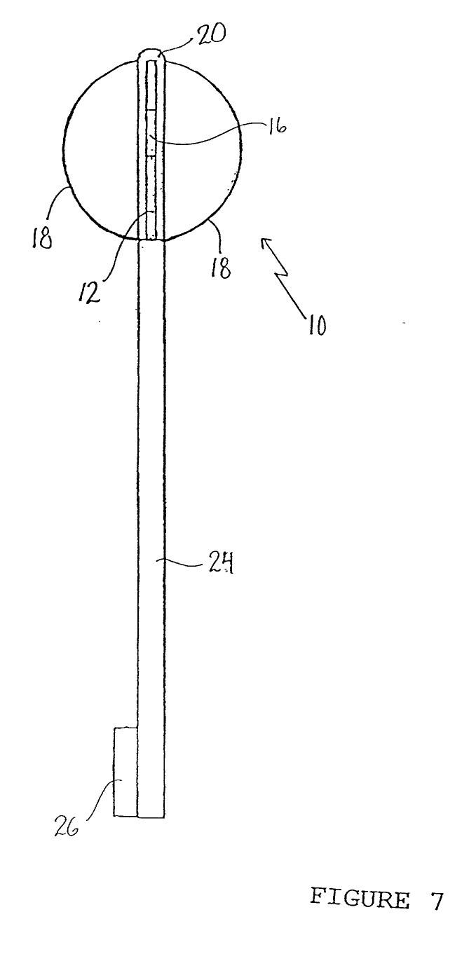

Referring to FIG. 1, wind direction indicator 10 includes a rigid planar body 12 that has a first end 14, a second end 16. Referring to FIG. 4, body also has opposed sides 15 and 17. Referring to FIGS. 4 and 5, deflectors 18 are positioned at first end 14 of body 12. Deflectors 18 extend outwardly from opposed sides 15 and 17 at first end 14 of body 12 at an angle toward second end 16 of body 12. Deflectors 18 serve a dual purpose of deflecting the body in response to wind movement and giving body 12 three dimensional visibility. Referring to FIG. 1, a pivotal mounting 20 is provided at first end 14 of body 12 for pivotally mounting body 12 for movement about a substantially vertical pivot axis 22. Referring to FIGS. 6 and 7, in the illustrated embodiment, a post 24 with a mounting plate 26 is provided for securing wind direction indicator 10 where wind direction indicator 10 is viewable by service personnel, however it will be appreciated that other methods are available for securing wind indicator 10 in place. Referring to FIG. 1, in the illustrated embodiment, mounting plate 26 has several apertures 28 that are adapted to receive a u-bolt 30 with securing nuts 32. Because of the arrangement of apertures 28, u-bolt 30 can be fitted around an existing post-like structure. U-bolt 30 is then secured through mounting plate 26 with nuts 32. Referring to FIG. 3, in the alternative, apertures 29 are provided on mounting plate 26 that can receive nails or screws 33 in the event that mounting plate 26 is to be mounted flush with a wall-like structure 34.

Operation:

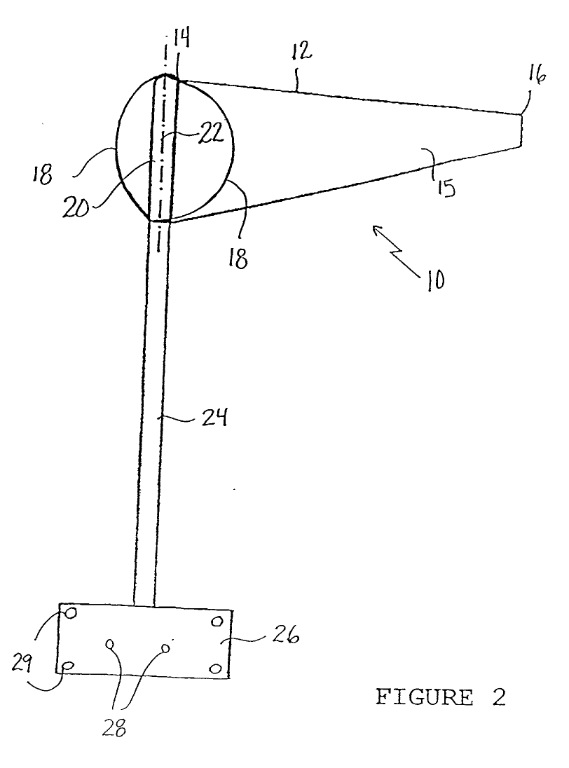

The use and operation of wind direction indicator 10 will now be described with reference to FIGS. 1 through 7. Referring to FIG. 1, wind direction indicator 10 can be situated at a sour gas well or anywhere it is required or desirable for service personnel to be able to accurately monitor the wind direction. Referring to FIGS. 2 and 3, pivotal mounting 20 allows body 12 to move around pivotal axis 22 in response to wind direction. Referring to FIGS. 4 and 5, deflectors 18 deflect body 12 in response to forces of wind, even in wind speeds insufficient to move windsocks. As a result, service personnel are able to more accurately assess the direction of wind by viewing the wind direction indictor 10. This is, of course, of particular importance in situations where a sour gas leak may have occurred. The outwardly projecting orientation of deflectors 18 provides three dimensional visibility which assists a person standing on the ground in determining wind position regardless from which angle they are viewing wind indicator 10.

Structure and Relationship of Parts:

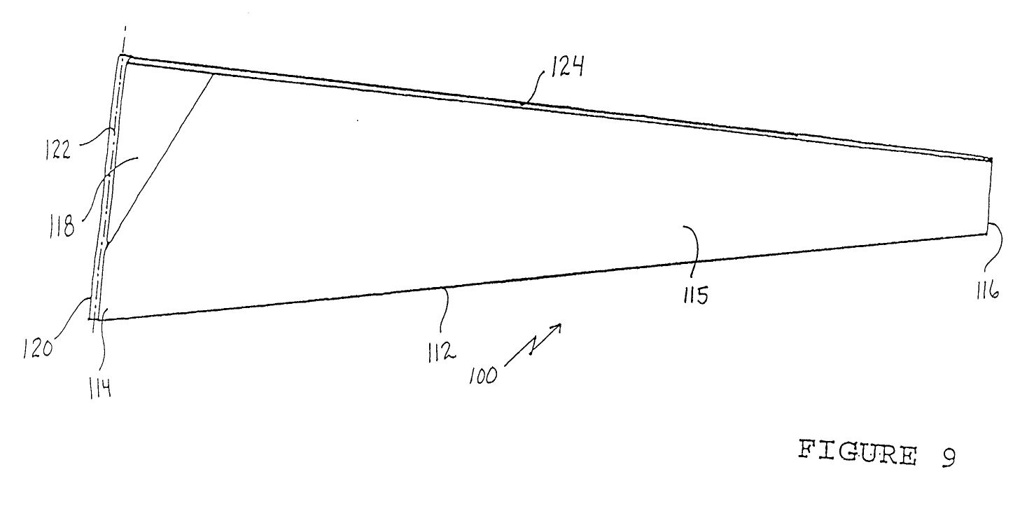

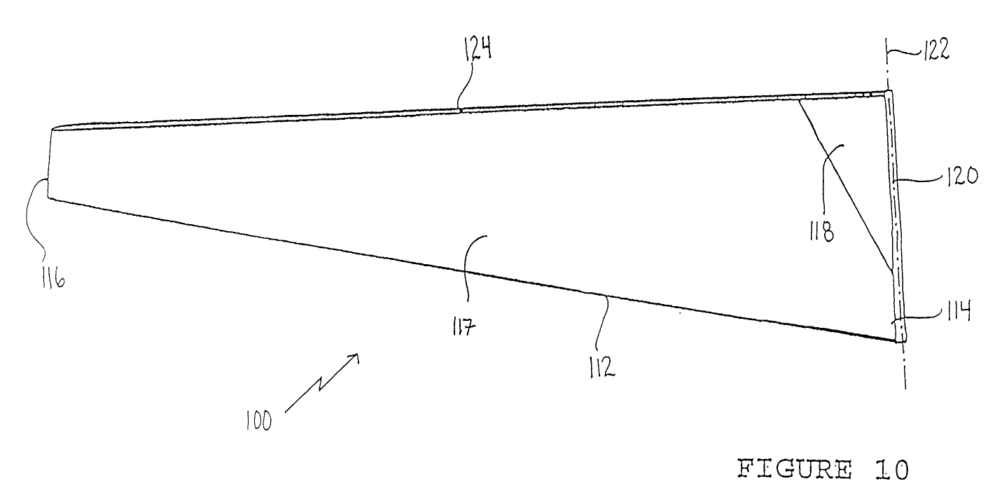

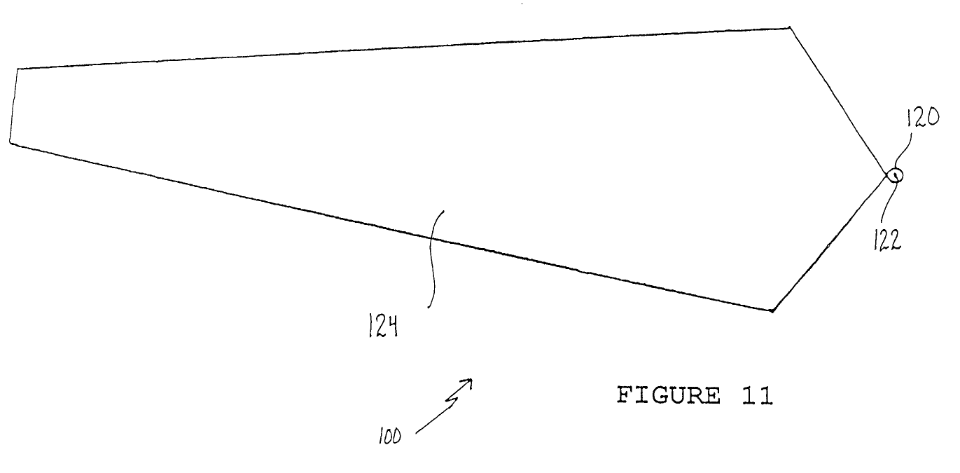

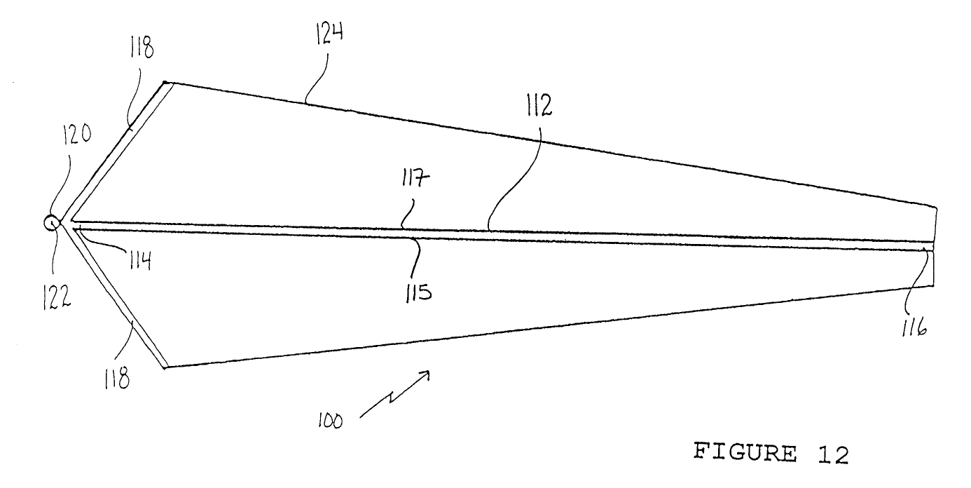

Referring to FIG. 8, an alternative embodiment of wind direction indicator 100 includes a rigid planar body 112 that has a first end 114, a second end 116. Referring to FIG. 12, body 112 also has opposed sides 115 and 117. Deflectors 118 are positioned at first end 114 of body 112. Deflectors 118 extend outwardly from opposed sides 115 and 117 at first end 114 of body 112 at an angle toward second end 116 of body 112. Referring to FIGS. 9 and 10, a pivotal mounting 120 is provided at first end 114 of body 112 for pivotally mounting body 112 for movement about a substantially vertical pivot axis 122. A top cap 124 is provide that overlies rigid planar body 112. Referring to FIG. 11, top cap 124 is tapered from first end 114 of body 112 to second end 116 of body 112, such that the orientation of body 112 can be determined from an aircraft.

Operation:

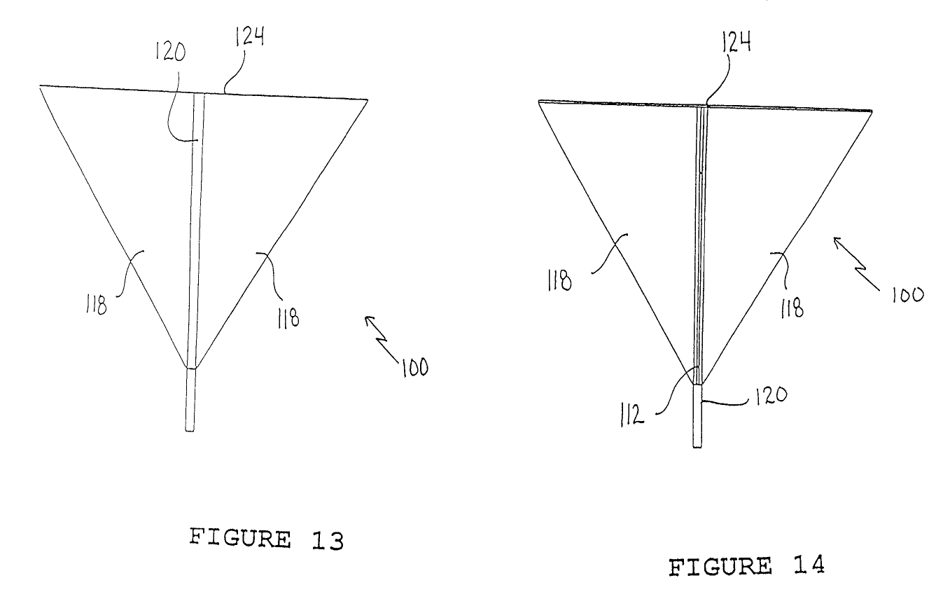

The use and operation of wind direction indicator 100 will now be described with reference to FIGS. 8 through 14. Referring to FIG. 8, wind direction indicator 100 can be situated at a sour gas well or anywhere it is required or desirable for service personnel to be able to accurately monitor the wind direction. Referring to FIGS. 9 and 10, pivotal mounting 120 allows body 112 to move around pivotal axis 122 in response to wind direction. Referring to FIGS. 13 and 14, deflectors 118 deflect body 112 in response to forces of wind, even in wind speeds insufficient to move windsocks. Referring to FIG. 11, top cap 124 enables service personnel to accurately assess the direction of wind when viewing wind direction indictor 100 in a helicopter hovering above the well site prior to landing.

It is important that both wind indicator 10 and wind indicator 100 turn freely. It is, therefore, important that friction in the mounting be minimized. Referring to FIG. 15, pivotally mounting 20 which permits body 12 to move about a substantially vertical pivot axis 22 includes a sleeve 36 which overlies a remote end 38 of a post 40 in mating relation. A ball 42 is secured at a remote end 44 of sleeve 36. Ball 42 provides point contact for rotation of sleeve 36 about 38 remote end of post 40.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A wind direction indicator, comprising:
a rigid body having a first end, a second end and opposed sides;
means for deflecting the body in response to wind movement that provides the body with three dimensional visibility;
means for pivotally mounting the body for movement about a substantially vertical pivot axis.

2. The wind direction indicator as defined in claim 1, wherein the shape and configuration of the body serves as means for deflecting the body in response to wind movement.

3. The wind direction indicator as defined in claim 1, wherein the means for deflecting the body in response to wind movement extends outwardly from the opposed sides of the body.

4. The wind direction indicator as defined in claim 3, wherein the means for deflecting the body in response to wind movement is positioned at the first end of the body.

5. The wind direction indicator as defined in claim 4, wherein the means for deflecting the body in response to wind movement are deflectors positioned at the first end of the body, the deflectors extending outwardly from the opposed sides at the first end of the body at an angle toward the second end of the body.

6. The wind direction indicator as defined in claim 1, wherein the means for pivotally mounting the body for movement about a substantially vertical pivot axis includes a sleeve which overlies a remote end of a post in mating relation, a ball being secured at a remote end of the sleeve, the ball providing point contact for rotation of the sleeve about the remote end of the post.

7. A wind direction indicator, comprising:
a rigid planar body having a first end and a second end;
deflectors positioned at the first end of the body, the deflectors extending outwardly from the first end of the body at an angle toward the second end of the body, such that the deflector serve the dual purpose of deflecting the body in response to wind movement and giving the body three dimensional visibility; and
a pivotal mounting for pivotally mounting the body for movement about a substantially vertical pivot axis.

8. The wind direction indicator as defined in claim 7, wherein the pivotal mounting is at the first end of the body.

9. The wind direction indicator as defined in claim 7, wherein a top cap overlies the rigid planar body, the top cap being tapered from the first end of the body to the second end of the body, such that the orientation of the body can be determined from an aircraft.

10. The wind direction indicator as defined in claim 7, wherein the means for pivotally mounting the body for movement about a substantially vertical pivot axis includes a sleeve which overlies a remote end of a post in mating relation, a ball being secured at a remote end of the sleeve, the ball providing point contact for rotation of the sleeve about the remote end of the post.

11. A wind direction indicator, comprising:
a rigid planar body having a first end and a second end;
deflectors positioned at the first end of the body, the deflectors extending outwardly from the opposed sides at the first end of the body at an angle toward the second end of the body, such that the deflector serve the dual purpose of deflecting the body in response to wind movement and giving the body three dimensional visibility;
a pivotal mounting at the first end of the body for pivotally mounting the body for movement about a substantially vertical pivot axis; and
a top cap overlying the rigid planar body, the top cap being tapered from the first end of the body to the second end of the body, such that the orientation of the body can be determined from an aircraft.
